(19) United States
(12) Patent Application Publication
(10) Pub. No.: US 2025/0044623 A1
(43) Pub. Date: Feb. 6, 2025

(54) ELECTRO-OPTIC ELEMENTS HAVING FASTER DISSOLVING SPACER BEADS

(71) Applicant: Gentex Corporation, Zeeland, MI (US)

(72) Inventor: Kevin L. Ash, Grand Rapids, MI (US)

(73) Assignee: Gentex Corporation, Zeeland, MI (US)

(21) Appl. No.: 18/789,907

(22) Filed: Jul. 31, 2024

Related U.S. Application Data
(60) Provisional application No. 63/530,729, filed on Aug. 4, 2023.

(51) Int. Cl. G02F 1/061

(52) U.S. Cl. CPC G02F 1/061; G02F 2201/12

(57) ABSTRACT

An electro-optic element includes a first substrate that has a first surface and a second surface substantially opposite the first surface. A second substrate has a third surface and a fourth surface substantially opposite the third surface. The second substrate is disposed in a spaced apart manner relative the first substrate such that the second and third surfaces face one another. A plurality of spacer beads are disposed between the second surface and the third surface. The plurality of spacer beads are formed of a material that is soluble in propylene carbonate and does not contain salt or polymers. A first substantially transparent electrode is associated with the second surface and a second substantially transparent electrode is associated with the third surface. An electro-optic medium contains propylene carbonate disposed between the first and second substantially transparent electrodes.

### CROSS-REFERENCE TO RELATED APPLICATION

This application claims priority to and the benefit under 35 U.S.C. § 119 (e) of U.S. Provisional Application No. 63/530,729, filed on Aug. 4, 2023, entitled “ELECTRO-OPTIC ELEMENTS HAVING FASTER DISSOLVING SPACER BEADS,” the disclosure of which is hereby incorporated herein by reference in its entirety.

### FIELD OF THE DISCLOSURE

The present disclosure generally relates to electro-optic elements that include dissolving spacer beads, the dissolving spacer beads, and a method of forming same.

### SUMMARY OF THE DISCLOSURE

According to one aspect of the present disclosure, an electro-optic element includes a first substrate that has a first surface and a second surface substantially opposite the first surface. A second substrate has a third surface and a fourth surface substantially opposite the third surface. The second substrate is disposed in a spaced apart manner relative the first substrate such that the second and third surfaces face one another. A plurality of spacer beads are disposed between the second surface and the third surface. The plurality of spacer beads are formed of a material that is soluble in propylene carbonate and does not contain salt or polymers. A first substantially transparent electrode is associated with the second surface and a second substantially transparent electrode is associated with the third surface. An electro-optic medium contains propylene carbonate disposed between the first and second substantially transparent electrodes.

According to another aspect of the present disclosure, an electro-optic element includes a first substrate that has a first surface and a second surface substantially opposite the first surface. A second substrate has a third surface and a fourth surface substantially opposite the third surface. The second substrate is disposed in a spaced apart manner relative the first substrate such that the second and third surfaces face one another. A first substantially transparent electrode is associated with the second surface and a second substantially transparent electrode is associated with the third surface. An electro-optic medium contains propylene carbonate and traces of a dissolved material. The electro-optic medium is disposed between the first and second substantially transparent electrodes. The traces of dissolved material include at least one of N-phenyl phthalimide and an anthraquinone.

According to yet another aspect of the present disclosure, a spacer bead for an electro-optic element includes a homogeneous material selected from a group including N-phenyl phthalimide, anthraquinone, and anthracene. The spacer bead includes an outer spherical surface and a center that defines a radius. The radius is between 50 and 2000 microns.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electro-optic element that includes spacer beads, in accordance with an aspect of the present disclosure;

FIG. 2A is a perspective view of an automobile that incorporates a structured light electro-optic element, in accordance with an aspect of the present disclosure;

FIG. 2B is a perspective view of an airplane that incorporates the structured light electro-optic element, in accordance with an aspect of the present disclosure;

FIG. 2C is a perspective view of a building that incorporates the structured light electro-optic element, in accordance with an aspect of the present disclosure;

FIG. 3 is a time-lapse illustrating spacer beads being dissolved in an electro-optic medium, in accordance with an aspect of the present disclosure;

FIG. 4 is a side view of a spacer bead, in accordance with an aspect of the present disclosure;

FIG. 5 is a side view of a spacer bead with an outer shell, in accordance with an aspect of the present disclosure;

FIG. 6 illustrates a flow chart of a method of forming an electro-optic element with spacer beads, in accordance with an aspect of the present disclosure; and

FIG. 7 illustrates a flow chart of a method of forming spacer beads for an electro-optic element, in accordance with an aspect of the present disclosure.

### DETAILED DESCRIPTION

The present illustrated embodiments reside primarily in combinations of method steps and apparatus related to electro-optic elements that include dissolving spacer beads and the dissolving spacer beads. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

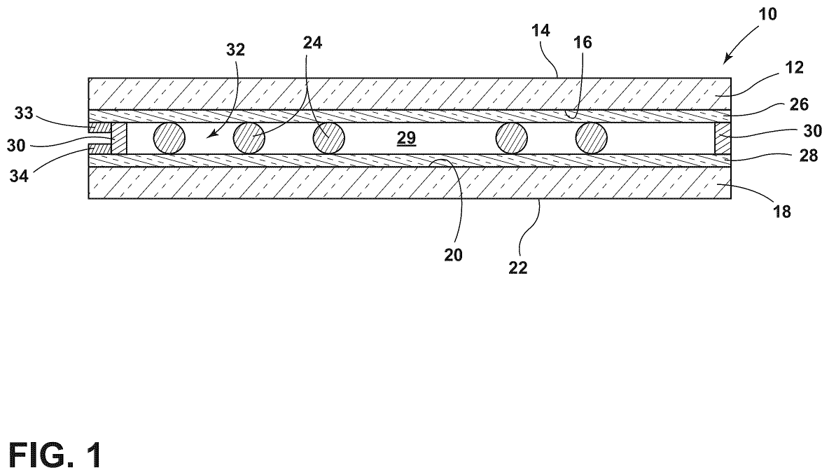

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIG. 1, reference numeral 10 generally designates an electro-optic element 10 including a first substrate 12 that has a first surface 14 and a second surface 16 substantially opposite the first surface 14. A second substrate 18 has a third surface 20 and a fourth surface 22 substantially opposite the third surface 20. The second substrate 18 is disposed in a spaced apart manner relative the first substrate 12 such that the second and third surfaces 16, 20 face one another. A plurality of spacer beads 24 are disposed between the second surface 16 and the third surface 20. The plurality of spacer beads 24 are formed of a material that is soluble in propylene carbonate and may not contain salt or polymers. A first substantially transparent electrode 26 is associated with the second surface 16 and a second substantially transparent electrode 28 is associated with the third surface 20. An electro-optic medium 29 contains propylene carbonate disposed between the first and second substantially transparent electrodes 26, 28.

With continued reference to FIG. 1, in some embodiments, the material of the spacer beads 24 includes N-phenyl phthalimide. For example, the material may be substantially entirely (e.g., more than 90%, more than 95%, or more than 99%) N-phenyl phthalimide and the material may be homogeneous. In this manner, the spacer beads 24 may dissolve in the propylene carbonate at a predictable rate. In some embodiments, the material of the spacer beads 24 includes an anthraquinone. For example, the material may be substantially entirely (e.g., more than 90%, more than 95%, or more than 99%) anthraquinone and the material may be homogeneous. In this manner, the spacer beads 24 may dissolve in the propylene carbonate at a predictable rate. It should also be appreciated that the spacer beads 24 may have other compositions, for example, a non-salt material mixed with a polymeric material and/or an anthracene.

The second substrate 18 may be disposed in a substantially parallel manner relative the first substrate 12. As such, the plurality of spacer beads 24 may each be substantially the same size to impart equal spacing between the first and second substrates 12, 18. The electro-optic element 10 may include an outer seal 30 that extends between the first and second substrates 12, 18 and defines a cavity 32 therebetween for holding and retaining the electro-optic medium 29. The outer seal 30 may be formed of an epoxy material. A first electrical bus 33 may be connected to the first substantially transparent electrode 26 and a second electrical bus 34 may be connected to the second substantially transparent electrode 28. More particularly, the electrical buses 33, 34 may provide an applied voltage to the first and second substantially transparent electrodes 26, 28. The applied voltage may change the electro-optic medium 29 between a substantially transmissive state and a partially transmissive state. A reflective layer and/or transreflective layer (not shown) may be located on the third or fourth surface 20, 22 of the second substrate 18, such that changes in transmissiveness (e.g., a reduction) increases the reflectivity of the electro-optic element 10. In some embodiments, the spacer beads 24 are located exclusively within the cavity 32. In other embodiments, the spacer beads 24 may be located exclusively outside of the cavity 32. In other embodiments, the spacer beads 24 may be located both inside and outside of the cavity 32.

The electro-optic medium 29 may include at least one solvent, at least one anodic material, and at least one cathodic material. Typically, both of the anodic and cathodic materials are electroactive and at least one of them may be electrochromic. It will be understood that regardless of its ordinary meaning, the term “electroactive” may mean a material that undergoes a modification in its oxidation state upon exposure to a particular electrical potential difference. Additionally, it will be understood that the term “electrochromic” may mean, regardless of its ordinary meaning, a material that exhibits a change in its extinction coefficient at one or more wavelengths upon exposure to a particular electrical potential difference. In some embodiments, the first and second substantially transparent electrodes 26, 28 may be formed by electrically conductive transparent materials, including, but not limited to, a transparent metal oxide (e.g., indium tin oxide, F: SnO2, ZnO, IZO), insulator-metal-insulator (“IMI”) structures, carbon (graphene and/or graphite) and/or a conductive metal mesh (e.g., nanowires).

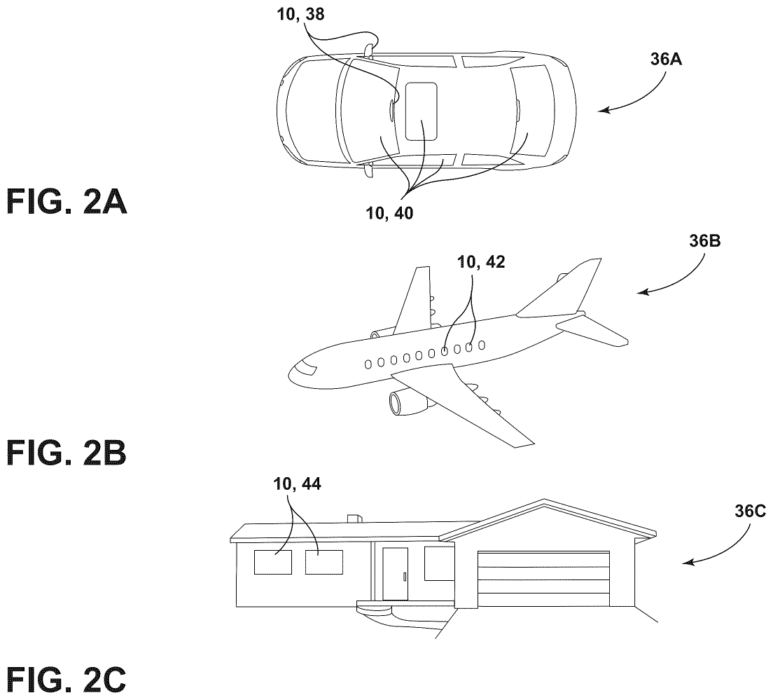

With reference now to FIGS. 2A-2C, the electro-optic element 10 may be incorporated with one or more structures 36A-36C. For example, FIG. 2A illustrates a vehicle 36A employing the electro-optic element 10. All or some components of the electro-optic element 10 may be located within, or at least partially form, a vehicle mirror 38 or a vehicle window 40. The vehicle 36A may include a commercial vehicle, an emergency vehicle, a residential vehicle, a train, or the like. FIG. 2B illustrates an airplane 36B employing the electro-optic element 10. The electro-optic element 10 may be located within, or at least partially form, an airplane mirror or an airplane window 42. FIG. 2C illustrates a building 36C employing the electro-optic element 10. The electro-optic element 10 may be located within, or at least partially form, a building window 44. Generally speaking, the electro-optic element 10 may be incorporated into any environment wherein changing transmittance and/or reflectivity is beneficial.

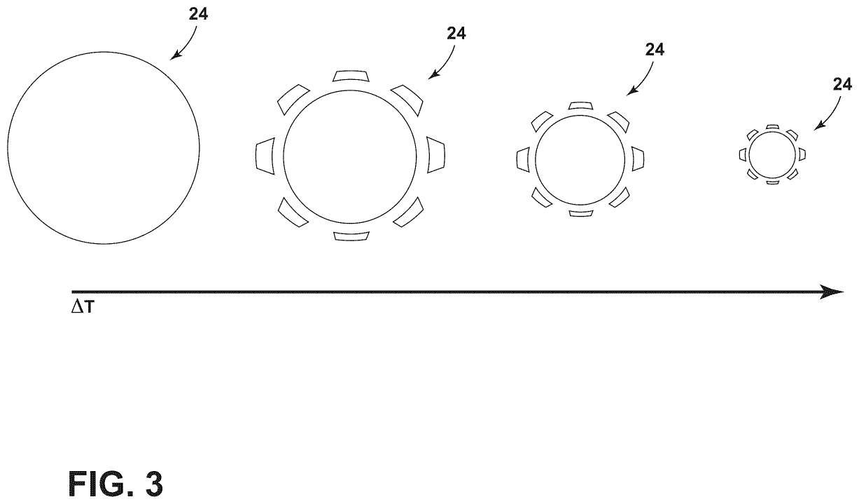

With reference now to FIG. 3, it should be appreciated that as the spacer beads 24 are submerged in the electro-optic medium 29, they begin to dissolve. As such, the electro-optic element 10 may be described as including an electro-optic medium 29 with traces of dissolved material. In some embodiments, the traces of dissolved material include at least one of N-phenyl phthalimide and an anthraquinone. In some embodiments, the traces of dissolved material do not include salt or polymeric material. In some embodiments, the traces may have other compositions, for example, a non-salt material mixed with a polymeric material and/or an anthracene. The spacer beads 24 dissolve over a course of time (“AT”) until the entire spacer bead 24 becomes fully dissolved. In some embodiments, the material of the spacer beads 24 may be or may include a dye such that the spacer beads 24 and traces of dissolved material are either substantially transparent, color neutral, or color matched to the electro-optic medium 29.

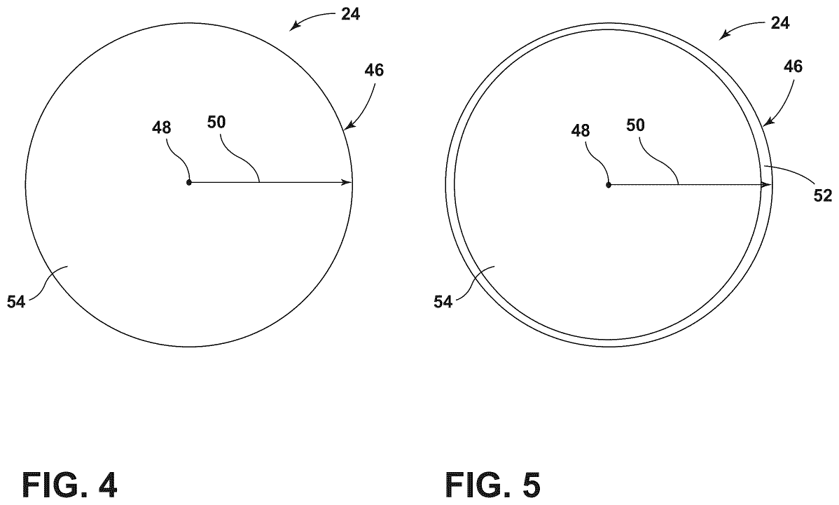

With reference now to FIGS. 4 and 5, one of the plurality of spacer beads 24 is exemplary illustrated. The spacer bead 24 may include a homogeneous material that includes one of N-phenyl phthalimide or an anthraquinone. As described previously, the spacer beads 24 may be formed of other materials (e.g., homogeneous materials) such as materials that do not include salt or polymeric material, a non-salt material mixed with a polymeric material, and/or an anthracene. The spacer bead 24 includes an outer spherical surface 46 and a center 48 that defines a radius 50. The radius 50 may be selected based on the distance between the first and second substrates 12, 18. The radius 50 may be between 50 microns and 2000 microns. For example, between 100 microns and 500 microns, less than 2000 microns, less than 1000 microns, less than 500 microns, more than 50 microns, more than 100 microns, or more than 500 microns. As shown in FIG. 5, the spacer bead 24 may include an outer shell 52 around the homogenous material (e.g., a spacer bead body 54) that defines the outer spherical surface 46. The outer shell 52 is formed of a shell material. For example, the shell material may be polymeric and the homogenous material may not include any salt or polymeric material. Therefore, in some embodiments, the dissolved material may include traces of polymeric material (e.g., from the outer shell 52). In some embodiments, the outer shell 52 includes a dye that is color matched with the electro-optic medium 29 and/or the homogenous material (e.g., the spacer bead body 54).

With continued reference now to FIGS. 4 and 5, the spacer bead 24 and, by extension, the resulting traces of dissolved material left in the electro-optic medium 29 after the spacer bead 24 has dissolved may include a variety of additional beneficial characteristics. For example, the material forming the spacer bead 24 may be selected from a variety of other materials that are soluble in propylene carbonate or other materials forming the electro-optic medium 29. Generally speaking, the material of the spacer bead 24 may not include salt or polymers (e.g., unless there is a polymeric outer shell 52). The material of the spacer bead 24 replaces traditional polymer-based spacers and includes rigidity, price point, commercial availability, formability, distinct properties that are not at risk of sublimation, ability to withstand temperatures above a curing temperature of the outer seal 30 and/or other components of the electro-optic element 10. In addition, the material of the spacer bead 24 (e.g., traces of dissolved material) must not negatively impact the user experience by influencing the reaction of the electro-optic medium 29 during changes in applied voltage (e.g., via color matching with dye).

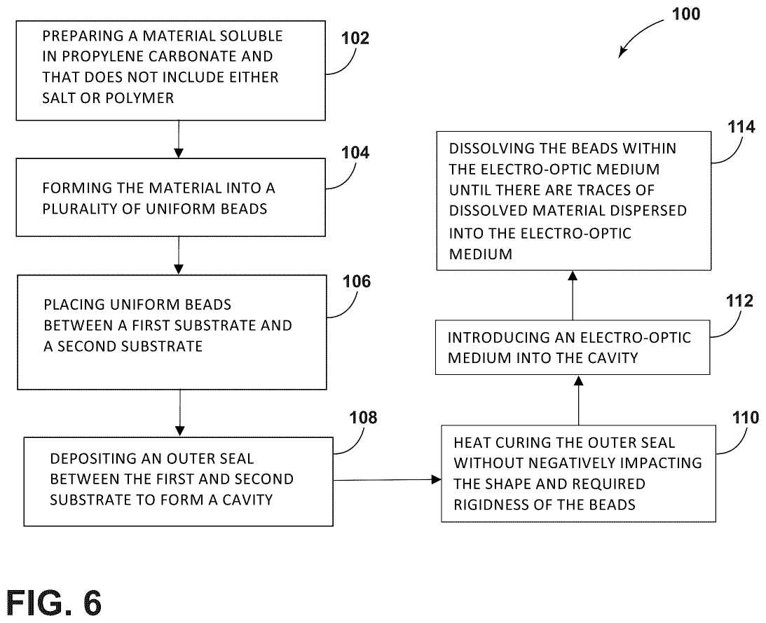

With reference now to FIG. 6, a method 100 of forming spacer beads 24 and an electro-optic element 10 with the spacer beads 24 is provided. The method 100 includes, at step 102, preparing a material soluble in propylene carbonate and that does not include either salt or polymer. For example, the material may be a homogeneous material that includes one of N-phenyl phthalimide or an anthraquinone. In other examples, the material (e.g., homogeneous material) may include materials that do not include salt or polymeric material, a non-salt material mixed with a polymeric material, and/or an anthracene. In some embodiments, the material may contain a dye that has been color matched. As such, step 102 may include a step of color matching a color of an electro-optic medium with the material via the introduction of a dye. Step 102 may further include forming an outer shell around the spacer bead 24. At step 104, the material is formed into a plurality of uniform beads (e.g., spacer beads 24). For example, the plurality of uniform beads may be spherically shaped. In some embodiments, the beads are formed with a prilling process. In some embodiments, an outer shell is formed around the bead. At step 106, the uniform beads are placed between a first substrate and a second substrate. For example, such that the spacing between the first and second substrates is defined uniformly by the beads. At step 108, the method 100 includes depositing an outer seal (e.g., out of epoxy) between the first and second substrate to form a cavity. In some embodiments, the beads are located exclusively within the cavity. In other embodiments, the beads may be located exclusively outside of the cavity. In other embodiments, the beads may be located both in and outside of the cavity. At step 110, the method 100 includes heat curing the outer seal without negatively impacting the shape and required rigidness of the beads. At step 112, the method 100 includes introducing an electro-optic medium into the cavity. At step 114, the method 100 includes dissolving the beads within the electro-optic medium until there are traces of dissolved material dispersed into the electro-optic medium.

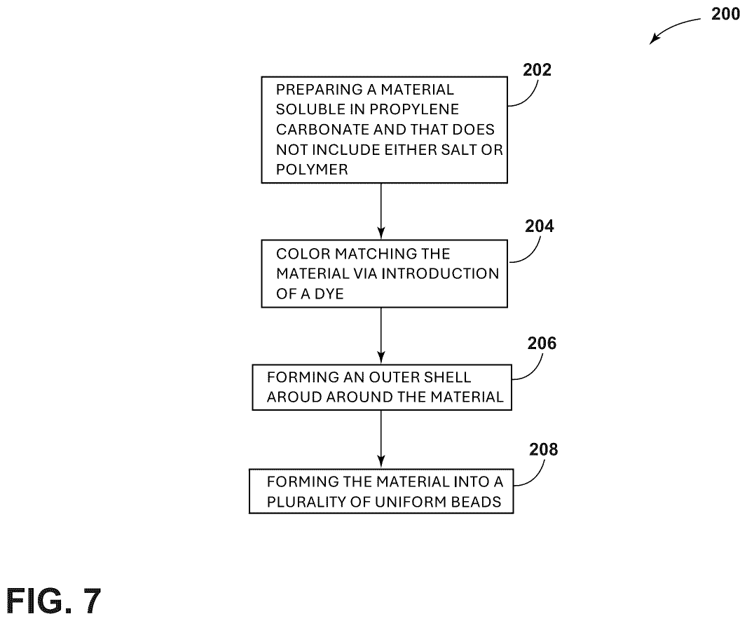

With reference now to FIG. 7, a method 200 of forming spacer beads 24 for an electro-optic element 10 is provided. The method 200 includes, at step 202, preparing a material soluble in propylene carbonate and that does not include either salt or polymer. For example, the material may be a homogeneous material that includes one of N-phenyl phthalimide or an anthraquinone. In other examples, the material (e.g., homogeneous material) may include materials that do not include salt or polymeric material, a non-salt material mixed with a polymeric material, and/or an anthracene. The method 200 may include, at step 204, color matching a color of an electro-optic medium that will be used in conjunction with the spacer bead 24 with the material of the spacer bead 24 via the introduction of a dye. The method 200 may include, at step 206, forming an outer shell (e.g., outer shell 52) around the spacer bead 24 (e.g., the spacer bead body 54). The outer shell may be polymeric. Step 206 may further include color matching the outer shell with the electro-optic medium 29 and/or the homogenous material (e.g., the spacer bead body 54). At step 208, the material is formed into a plurality of uniform beads (e.g., spacer beads 24). For example, the plurality of uniform beads may be spherically shaped. In some embodiments, the beads are formed at step 208 with a prilling process. Step 208 may further include determining a size of the beads defined by a radius from a center of the bead to the outer surface of the homogeneous material or, when present, the outer surface of the outer shell. The size may be determined based on a desired spacing of an electro-optic assembly. In some examples, the radius may be between 50 microns and 2000 microns. For example, between 100 microns and 500 microns, less than 2000 microns, less than 1000 microns, less than 500 microns, more than 50 microns, more than 100 microns, or more than 500 microns. After assembly, the beads may be utilized, for example, in the electro-optic assembly 10 depicted in FIG. 1, and the steps 106-114 depicted in FIG. 6.

The disclosure is further summarized in the following paragraphs and is further characterized by combinations of any and all of the various aspects described therein.

According to one aspect of the present disclosure, an electro-optic element includes a first substrate that has a first surface and a second surface substantially opposite the first surface. A second substrate has a third surface and a fourth surface substantially opposite the third surface. The second substrate is disposed in a spaced apart manner relative the first substrate such that the second and third surfaces face one another. A plurality of spacer beads are disposed between the second surface and the third surface. The plurality of spacer beads are formed of a material that is soluble in propylene carbonate and does not contain salt or polymers. A first substantially transparent electrode is associated with the second surface and a second substantially transparent electrode is associated with the third surface. An electro-optic medium contains propylene carbonate disposed between the first and second substantially transparent electrodes.

According to another aspect, the material includes N-phenyl phthalimide.

According to yet another aspect, the material is substantially entirely N-phenyl phthalimide and the material is homogeneous.

According to still yet another aspect, the material includes an anthraquinone.

According to another aspect, the material is substantially entirely anthraquinone and the material is homogeneous.

According to yet another aspect, the second substrate is disposed in a substantially parallel manner relative the first substrate.

According to another aspect, the material includes an anthracene.

According to still another aspect, the material includes a dye that is color matched to the electro-optic medium.

According to yet another aspect, an outer shell is formed over the material.

According to another aspect of the present disclosure, an electro-optic element includes a first substrate that has a first surface and a second surface substantially opposite the first surface. A second substrate has a third surface and a fourth surface substantially opposite the third surface. The second substrate is disposed in a spaced apart manner relative the first substrate such that the second and third surfaces face one another. A first substantially transparent electrode is associated with the second surface and a second substantially transparent electrode is associated with the third surface. An electro-optic medium contains propylene carbonate and traces of a dissolved material. The electro-optic medium is disposed between the first and second substantially transparent electrodes. The traces of dissolved material include at least one of N-phenyl phthalimide and an anthraquinone.

According to another aspect, the dissolved material includes N-phenyl phthalimide.

According to still another aspect, the dissolved material includes anthraquinone.

According to yet another aspect, the dissolved material includes a dye that is color matched to the electro-optic medium.

According to another aspect, an electro-optic element includes a dissolved outer shell that is at least partially polymeric.

According to yet another aspect of the present disclosure, a spacer bead for an electro-optic element includes a homogeneous material selected from a group including N-phenyl phthalimide, anthraquinone, and anthracene. The spacer bead includes an outer spherical surface and a center that defines a radius. The radius is between 50 and 2000 microns.

According to another aspect, the homogenous material includes N-phenyl phthalimide.

According to still another aspect, the homogenous material includes anthraquinone.

According to yet another aspect, the homogenous material does not contain salt or polymers.

According to another aspect, a spacer bead for an electro-optic element includes an outer shell defining the outer spherical surface, the outer shell formed of a shell material that is different than the homogenous material.

According to still another aspect, the homogenous material includes a dye that is color matched with a selected electro-optic medium.

According to yet another aspect, the shell material is polymeric.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic element, comprising:
a first substrate having a first surface and a second surface substantially opposite the first surface;
a second substrate having a third surface and a fourth surface substantially opposite the third surface, the second substrate disposed in a spaced apart manner relative the first substrate such that the second and third surfaces face one another;
a plurality of spacer beads disposed between the second surface and the third surface, the plurality of spacer beads formed of a material that is soluble in propylene carbonate and does not contain salt or polymers;
a first substantially transparent electrode associated with the second surface;
a second substantially transparent electrode associated with the third surface; and
an electro-optic medium containing propylene carbonate disposed between the first and second substantially transparent electrodes.

2. The electro-optic element of claim 1, wherein the material includes N-phenyl phthalimide.

3. The electro-optic element of claim 2, wherein the material is substantially entirely N-phenyl phthalimide and the material is homogeneous.

4. The electro-optic element of claim 1, wherein the material includes anthraquinone.

5. The electro-optic element of claim 4, wherein the material is substantially entirely anthraquinone and the material is homogeneous.

6. The electro-optic element of claim 1, wherein the second substrate is disposed in a substantially parallel manner relative the first substrate.

7. The electro-optic element of claim 1, wherein the material includes an anthracene.

8. The electro-optic element of claim 1, wherein the material includes a dye that is color matched to the electro-optic medium.

9. The electro-optic element of claim 1, wherein an outer shell is formed over the material.

10. An electro-optic element, comprising:
a first substrate having a first surface and a second surface substantially opposite the first surface;
a second substrate having a third surface and a fourth surface substantially opposite the third surface, the second substrate disposed in a spaced apart manner relative the first substrate such that the second and third surfaces face one another;
a first substantially transparent electrode associated with the second surface;
a second substantially transparent electrode associated with the third surface;
an electro-optic medium containing propylene carbonate and traces of a dissolved material, the electro-optic medium disposed between the first and second substantially transparent electrodes; and
the traces of dissolved material including at least one of N-phenyl phthalimide and anthraquinone.

11. The electro-optic element of claim 10, wherein the dissolved material includes N-phenyl phthalimide.

12. The electro-optic element of claim 10, wherein the dissolved material includes anthraquinone.

13. The electro-optic element of claim 10, wherein the dissolved material includes a dye that is color matched to the electro-optic medium.

14. The electro-optic medium of claim 13, further including a dissolved outer shell that is at least partially polymeric.

15. A spacer bead for an electro-optic element, comprising:
a homogeneous material selected from a group including N-phenyl phthalimide, anthraquinone, and anthracene;
an outer spherical surface and a center defining a radius; and
the radius being between 50 and 2000 microns.

16. The spacer bead of claim 15, wherein the homogenous material includes N-phenyl phthalimide.

17. The spacer bead of claim 15, wherein the homogenous material includes anthraquinone.

18. The spacer bead of claim 15, wherein the homogenous material does not contain salt or polymers.

19. The spacer bead of claim 15, further including an outer shell defining the outer spherical surface, the outer shell formed of a shell material that is different than the homogenous material.

20. The spacer bead of claim 15, wherein the homogenous material includes a dye that is color matched with a selected electro-optic medium.
